(19) United States
(12) Patent Application Publication
(10) Pub. No.: US 2021/0308837 A1
(43) Pub. Date: Oct. 7, 2021

(54) PLIER JAW MODIFIER BODY

(71) Applicant: Aaron HOLMBERG, Omaha, NE (US)

(72) Inventor: Aaron HOLMBERG, Omaha, NE (US)

(21) Appl. No.: 17/222,907

(22) Filed: Apr. 5, 2021

Related U.S. Application Data
(60) Provisional application No. 63/005,255, filed on Apr. 4, 2020.

(51) Int. Cl. B25B 7/02; B25B 7/06

(52) U.S. Cl. CPC B25B 7/02; B25B 7/06

(57) ABSTRACT

A plier and jaw modifier body for use with a plier. The plier has a pair of opposing jaws. There is a jaw modifier body coupled to each of the opposing jaws via at least one coupler. The coupler can be a screw, bolt, or the like, or it can be a magnet. Each jaw modifier body has at least one working surface to engage a work piece. The jaw modifier body can be coupled and decoupled to the plier jaws to provide customization and versatility to pliers. Various working surfaces can be utilized to hold and manipulate various work pieces.

### PRIORITY

This application claims priority to U.S. provisional patent application No. 63/005,255 filed Apr. 4, 2020, the entirety of both are incorporated herein by reference.

### BACKGROUND OF THE INVENTION

### Technical Field

The present invention relates to a system and method for monetizing underused assets.

### Description of Related Art

Currently, there are a number of solutions for modifying plier's jaws. Some of these solutions attempt to replace the entire jaw, but these solutions fail to meet the needs of the industry because of the high cost and the difficulty of swapping jaws. Other solutions attempt to sell multiple pliers with different jaws, but these solutions are similarly unable to meet the needs of the industry because of the expense and tool box space required. Still, other solutions seek to redesign the clamps, but these solutions also fail to meet industry needs because of their added expense or inferior mechanism on the pliers. Still other solutions involve the permanent modification of pliers by their users to fit a custom application. This fails to meet industry needs because the hand tool is then dedicated to a specific task otherwise making it useless for other applications. Consequently, there is a need for a device which allows for multiple working surfaces for a plier.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a perspective view of the modified pliers in one embodiment;

FIG. 2 is an exploded view of a modified plier in one embodiment;

FIG. 3 is a perspective view of pliers in a closed position in one embodiment;

FIG. 4 is an exploded perspective view of the jaw modifiers in one embodiment with standard locking pliers shown for example;

FIG. 5 is a perspective view of the modifier body of FIG. 4;

FIG. 6 shows one embodiment of the C-clamp pliers jaw modifiers;

FIG. 7 shows one embodiment of the C-clamp pliers jaw modifiers;

FIG. 8 shows one embodiment of the C-clamp pliers jaw modifiers;

FIG. 9A is a side profile view of a jaw modified body;

FIG. 9B is a perspective view of a jaw modified body;

FIG. 10A is a side profile view of a jaw modified body;

FIG. 10B is a perspective view of a jaw modified body;

FIG. 11 is a perspective view of a C-clamp pliers jaw modifier;

FIG. 12 shows a perspective view of the jaw modifier for C-clamp pliers in one embodiment;

FIG. 13 shows one embodiment of the C-clamp pliers jaw modifiers with corner chamfers;

FIG. 14 shows one embodiment of the C-clamp pliers jaw modifiers with a third coupler 1 below the clamping jaw;

FIG. 15 shows one embodiment of the C-clamp pliers jaw modifiers with a slot in the back for receiving a plier jaw;

FIG. 16 shows one embodiment of the C-clamp pliers jaw modifiers with an elongated clamping surface;

FIG. 17 shows one embodiment of the C-clamp pliers jaw modifiers with a form that can be placed within the “C” portion of the locking pliers.

### DETAILED DESCRIPTION

Several embodiments of Applicant's invention will now be described with reference to the drawings. Unless otherwise noted, like elements will be identified by identical numbers throughout all figures. The invention illustratively disclosed herein suitably may be practiced in the absence of any element which is not specifically disclosed herein.

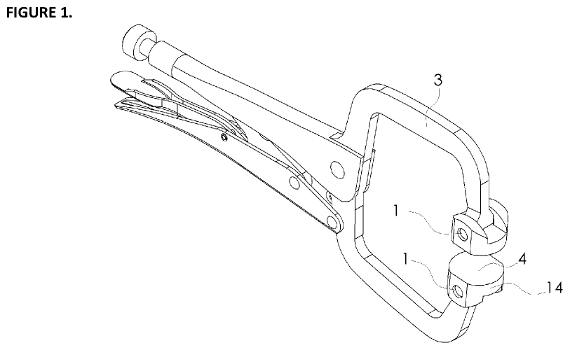

FIG. 1 is a perspective view of the modified pliers in one embodiment. In one embodiment a plier is disclosed but this is for illustrative purposes only as any hand tool can be used. A hand tool used for gripping or applying force to a work piece composed of at least one handle and one jaw. In one embodiment the tool comprises a set of pliers which have two opposing jaws 3. Coupled to the opposing jaws 3 are jaw modifier bodies 14. The jaw modifier body 14, in one embodiment, is comprised of a slotted section between the couplers 1 that allows the pliers jaws 3 to assist in aligning and retaining the jaws 3 while in the locked position. In one embodiment, the slotted jaw modifier body 14 will have a geometry on the opposing face, the working surface 4, to the groove that is designed to improve the interface for the specific job. Often various work pieces, or the object being held or manipulated by the pliers, have different shapes or sizes. Varying the surface which contacts the work pieces, the working surface 4, assists the user in better grasping, positioning, and manipulating the work piece.

It should be noted that the body of the jaw modifier 14 can comprise virtually any material, including but not limited to glass filled plastic, plastic, aluminum, steel, or hardened steel, other metals, plastics, and combinations thereof.

The jaw modifier body 14 is coupled to the jaws 3 of the plier via a coupler 1. The coupler can comprise virtually any mechanical solution which can couple a body 14 to a jaw. This includes screws, bolts, magnets, cams, adhesives, etc. A permanent coupling refers to a coupling which requires tools to decouple. Thus, if the body 14 is coupled to the jaws 3 via a screw, such as a set screw, that is referred to as a permanent coupling as it requires the use of a screwdriver or other tool to decouple the body 14 from the jaws. In some embodiments permanent coupling is preferred but in other embodiments it is not preferred. A non-permanent coupling refers to a coupling which does not require external tools to couple and decouple. As an example, magnets can be used as the coupler 1 to couple and decouple the body 14 from the jaws 3. Non-permanent coupling provides fast and easy swapping of the jaw modifier body 14 compared to permanent coupling. This is an advantage, in some embodiments, whereby the user wants to be able to quickly swap between bodies 14.

FIG. 1 shows standard locking pliers with one variation of the magnetically affixed tip modifiers, couplers 1, installed. In this embodiment, the jaw modifiers 14 has uses magnets as the coupler 1, which are embedded into the body of the jaw modifier 14. As shown there are two magnets on either side of the pliers jaws. This enables the magnetic flux to be carried through the jaw which helps to better secure the jaws. When placed onto the pliers the magnets keep the jaws in place while not actively clamped. Once clamped, the jaws press into a channel between the magnets mechanically locking the jaw modifiers 14 to the plier jaws 3. As shown, the working surface 4 has a flat face for distributing force over a greater area. This working surface 4 face can be coated with a soft or hard material, which includes but is not limited to aluminum, hardened steel, plastic, rubber or foam. As noted, the jaw modifiers 14 can be manufactured out of any material that will maintain structural integrity while clamping force is applied.

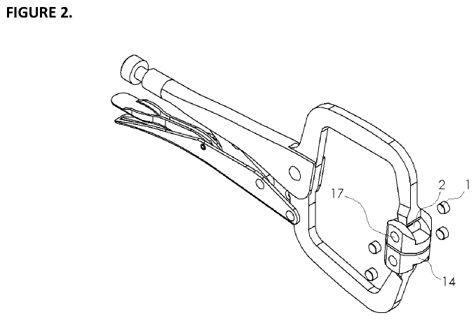

FIG. 2 is an exploded view of a modified plier in one embodiment. FIG. 2 shows an exploded view of the magnetically affixed jaw modifier with C-clamp style pliers in place for demonstration. The couplers 1, which are magnets in this embodiment, are permanently affixed to the jaws modifier body. A groove 2 is created in the jaw modifier body during the drilling operations. This groove 2 helps mechanically affix the pliers jaws 3 to the jaw modifiers 14 while clamping force is being applied. In one embodiment the groove 2 is sized so as to receive the end of the jaws 3 snuggly. The magnets help hold the jaw modifiers in place while no clamping force is being applied.

FIG. 2 also shows holes 17 which are used to house and receive the couplers 1. The holes 17 can be drilled, cut, etc. into the jaw modifier body 14.

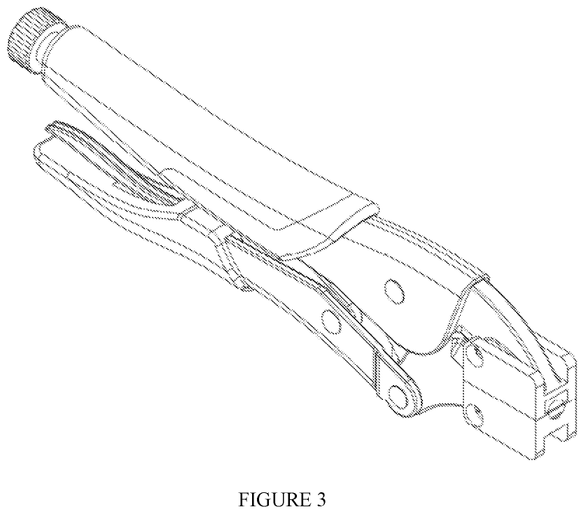

Turning to FIG. 3, FIG. 3 is a perspective view of pliers in a closed position in one embodiment. FIG. 3 shows an assembly of standard pliers with magnetically affixed jaw modifiers 14. The jaw modifiers 14 pictured are designed to grip pins. This is one specific design of the working surface 4 face and is for illustrative purposes only and should not be deemed limiting. Other variations, discussed herein, include v-grooved surfaces for gripping round objects. They could also have hex shaped jaws for gripping threaded nuts.

The jaw modifiers 14 can be made out of soft material or hard materials depending on the application. Examples of materials that could be used are aluminum or plastic for soft material or tool steels such as boronized steels, carbide brazed or welded steels, carborized, carbonitrided or heat treated steels. This is not a comprehensive list of materials that could be used in the jaw modifier body 14.

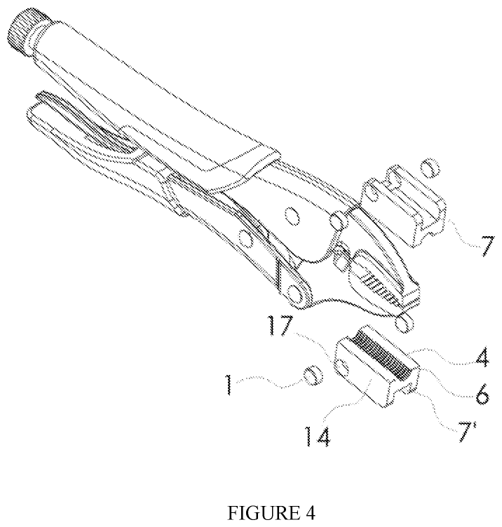

Turning now to FIG. 4, FIG. 4 is an exploded perspective view of the jaw modifiers in one embodiment with standard locking pliers shown for example. The jaw modifiers 14 shown have semi-circular channels 6 on the clamping working surface 4. These semi-circular channels 6, which can be partial threads, can be hardened so the jaws can bite onto a pin when clamping force is applied with the pliers. In this embodiment the magnets are permanently affixed to the jaw modifier body 14 and are used to magnetically affix the jaw modifiers 14 to the pliers jaws 3 when clamping force is not applied. The channel 7 in the jaw modifiers 14 is used to align the jaw modifier 14 to the pliers jaws 3. While not shown here, the channel 7 can be form fit to the jaws 3 to assist with grip. The channel 7 is a void which allows the modifier body 14 to receive the jaws 3.

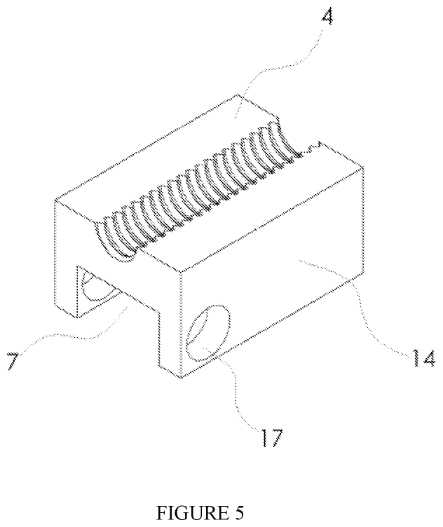

FIG. 5 is a perspective view of the modifier body 14 of FIG. 4. FIG. 5 shows one embodiment of the standard locking pliers jaw modifiers 14. This embodiment has a semi-circular channel 6 on the working surface 4. These semi-circular channels 6 can have serrations as shown. They can be hardened to help in gripping hardened pins such as spring pins or dowel pins. The hole 17 in the side is used to permanently affix couplers 1, such as magnets, to the jaw modifier body 14. The channel 7 helps align the jaw modifier with the pliers jaws 3.

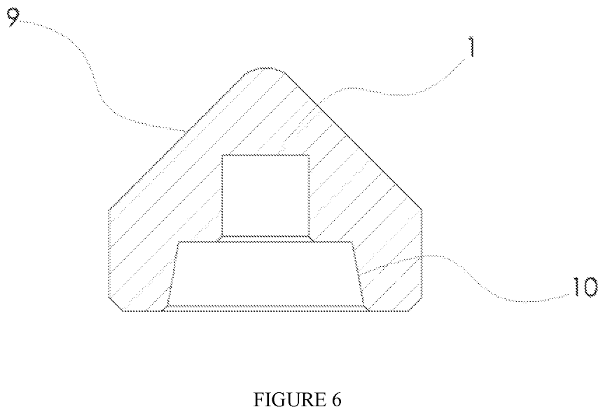

FIG. 6 shows one embodiment of the C-clamp pliers jaw modifiers 14. This embodiment has a conical jaw for the work engagement surface. As shown, the couplers 1 are housed as depicted. The small pocket in the center is used to house the couplers 1. In one embodiment permanently affixed magnets are inserted to the jaw modifier body 14 using a press fit or adhesive. The counter bore 10 helps align the jaw modifier 14 with the pliers jaws 3. This jaw modifier 14 can be used for clamping work pieces with holes or other features that the conical form can engage better than the standard pliers jaw. As shown, the working surface 4 is non-planar. Specifically, the working surface 4 has at least one protrusion 9 which extends out beyond the planar surface of the working surface 4. The size, shape, and profile of the working surface 4 can be modified and adapted depending upon the work piece.

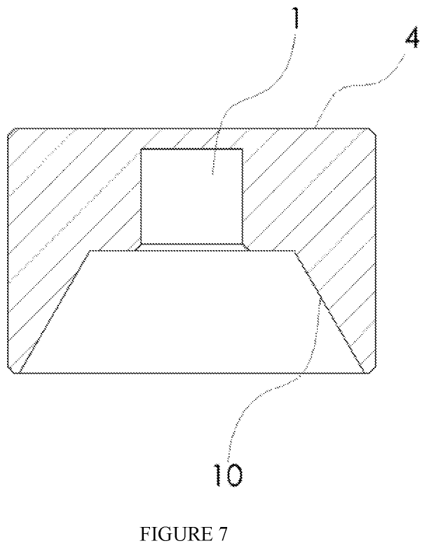

FIG. 7 shows one embodiment of the C-clamp pliers jaw modifiers. This embodiment has a flat and planar working surface fact 4. Like FIG. 6, the small pocket in the center is used to permanently affix couplers 1, such as magnets, to the jaw modifier body 14 using a press fit or adhesive. The counter bore 10 helps align the jaw modifier with the pliers jaw 3. This jaw modifier 14 can be used for clamping work pieces with flat surfaces that would be damaged if standard pliers jaws were used.

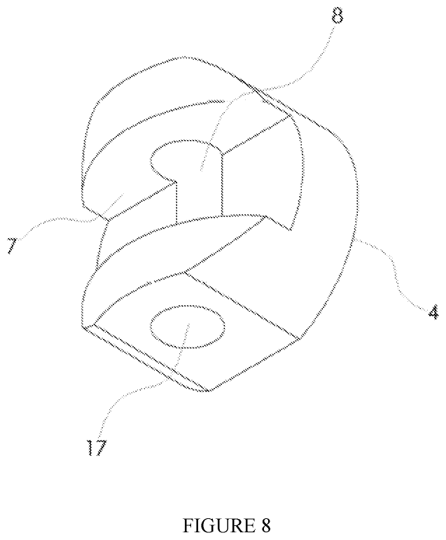

FIG. 8 shows one embodiment of the C-clamp pliers jaw modifiers. This embodiment has a flat face as the working surface 4. The two holes 17 in the side are used to permanently affix couplers 1, such as magnets, to the jaw modifier body 14 using a press fit or adhesive. The transverse channel 8 formed while drilling the coupler holes 17 is used to help center the jaw modifiers 14 with the pliers jaws 3. It also locks the jaw modifiers 14 into place when a workpiece is engaged. The channel 7 cut through the body of the type modifier allows the pliers jaws 3 to engage the couplers 1. When the couplers 1 are magnets, the magnetic poles are aligned north facing south so the magnetic flux is guided through the pliers jaws 3 when the jaw modifier 14 is installed. This jaw modifier 14 can be used for clamping work pieces with soft flat surfaces that would be damaged if the pliers jaws were not covered or a sacrificial material was placed between the workpiece and the pliers jaws.

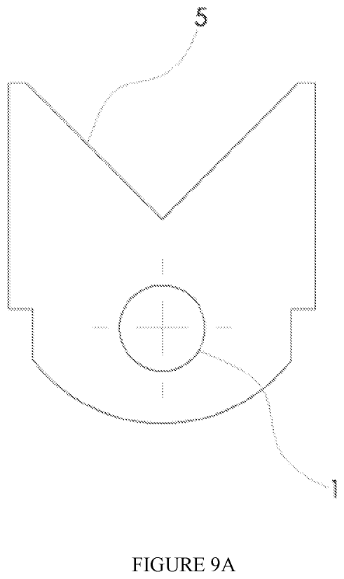

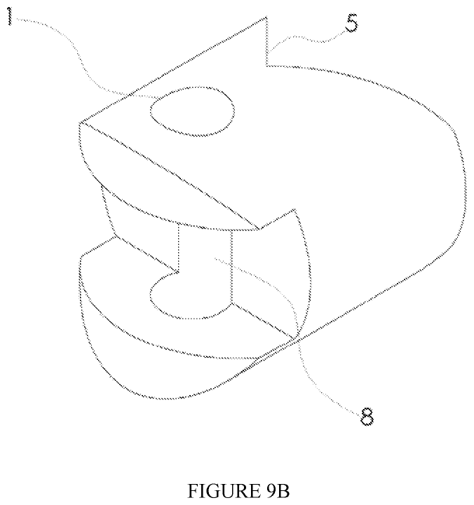

FIG. 9A is a side profile view of a jaw modified body; FIG. 9B is a perspective view of a jaw modified body. FIGS. 9A and 9B show one embodiment of the C-clamp pliers jaw modifiers with a V-grooved face 5 for the working surface 4. This embodiment has a 90 degree v-grooved face 5 for the work engagement surface. This jaw modifier 14 can be used for clamping against a corner, or on round work pieces that would be challenging with standard jaw geometry. While one a single V-grooved face 5 is shown, in other embodiments, there can be multiple V-grooved faces. As an example, the shape can have a W-shape.

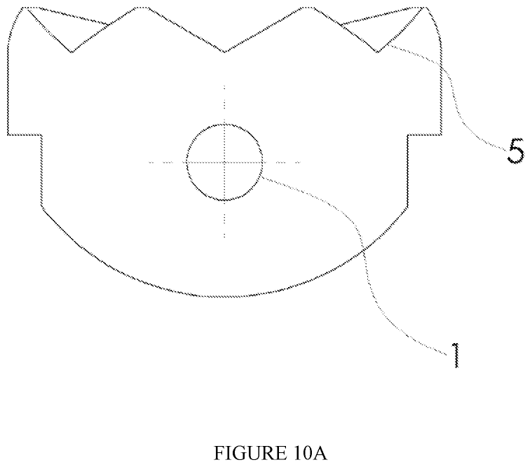

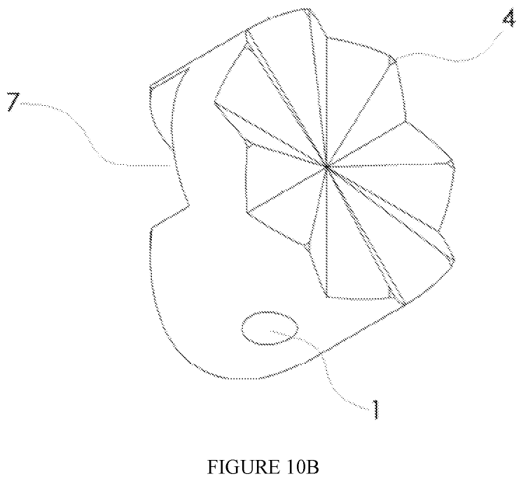

FIG. 10A is a side profile view of a jaw modified body, and FIG. 10B is a perspective view of a jaw modified body. FIG. 10 shows one embodiment of the C-clamp pliers jaw modifiers. This embodiment has a v-grooved face 5 in various orientations for the working surface 4. There are grooves across the face in multiple directions designed so the workpiece can be clamped at different angles relative to the pliers body. This jaw modifier 14 can be used for clamping on round work pieces that would be challenging with standard jaw geometry.

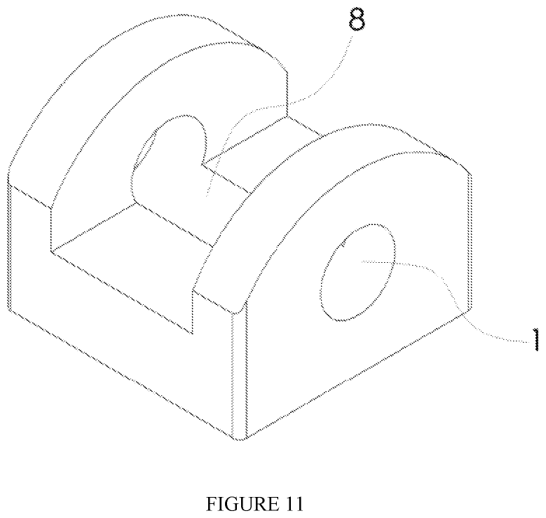

FIG. 11 is a perspective view of a C-clamp pliers jaw modifier. This embodiment has a flat face or planar working surface 4. This embodiment also has a square body. The two couplers 1, magnets affixed in the side holes 17 are used to hold the jaw modifiers 14 onto the pliers jaws 3 but can also be used to hold work pieces on the side of the jaw modifier. The square form and flat face enables the piece held by the side magnets to stand perpendicular to the side. Not shown here, the sides can be extended and multiple magnets installed to help stabilize the magnetically held component perpendicular to the pliers held component. Thus, while embodiments have been shown utilizing two couplers on each jaw modifier body 14, this is for illustrative purposes only and should not be deemed limiting. In other embodiments, one, two, three, or more couplers 1 can be utilized. Additional couplers 1 increase the stability and further couple the jaw modifier body 14 to the jaws 3.

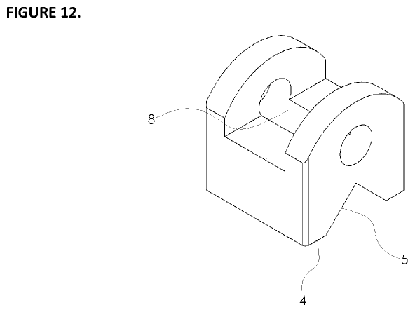

FIG. 12 shows a perspective view of the jaw modifier for C-clamp pliers in one embodiment. This embodiment has a 90 degree v-grooved face 5 for the working surface 4. This jaw modifier 14 can be used for clamping against a corner, flat surfaces that need access to the seam, or on round work pieces that would be challenging with standard jaw geometry. The square body geometry enables iron components to be magnetically affixed to the side perpendicular to the work piece.

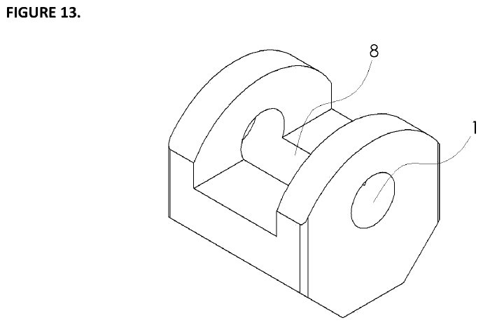

FIG. 13 shows one embodiment of the C-clamp pliers jaw modifiers with corner chamfers. This embodiment has large 45 degree corner chamfers 13 on the working surface 4. This jaw modifier 14 can be used for clamping against inside corners, in channels, or on flat surfaces. When magnets are used as the coupler 1, the square body geometry enables iron components to be magnetically affixed to the side perpendicular to the work piece.

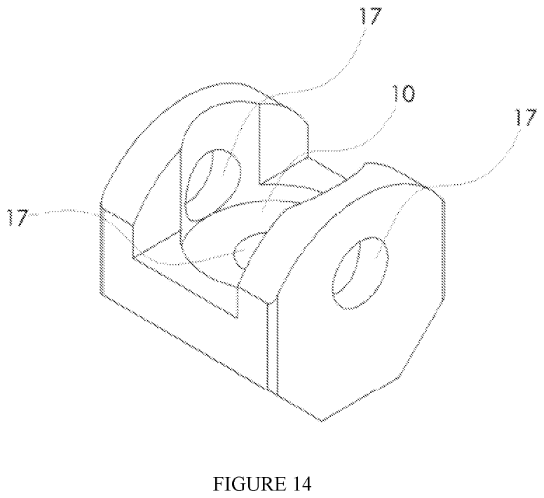

FIG. 14 shows one embodiment of the C-clamp pliers jaw modifiers with a third coupler 1 below the clamping jaw 3. As shown, the jaw modifier body 14 has three holes 17 to house couplers 1. The modifier body 14 also has a counter bore 10 large enough such that the jaw modifier can be rotated relative to the body after clamping. When the couplers 1 comprise magnets, the side magnets realign the jaw modifier 14 with the pliers body 3 after the jaws are disengaged from the workpiece.

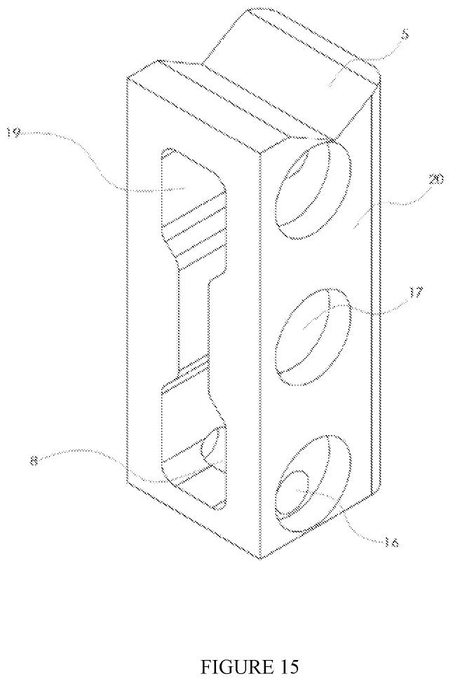

FIG. 15 shows one embodiment of the C-clamp pliers jaw modifiers with a slot 19 in the back for receiving a plier jaw 3. The slot 19 can comprise virtually any shape which can coordinate with a plier jaw 3. As depicted, the slot 19 comprises an hour-glass shape. The hour-glass shape enables the orientation of the engagement to be flipped 180 degrees. In other words, the plier jaws 3 can engage from the top or the bottom of the slot 19. In this fashion, two opposing and working surfaces 4 can be presented. As depicted, the first working surface 4 comprises a V-shaped face whereas the bottom working surface 4 comprises a planar surface. Thus, in some embodiments each jaw modifier body 14 offers two separate working surfaces 4. In one embodiment each separate working surface 4 is different. This allows the same jaw modifier body 14 to offer different options for working surfaces 4. The user can use a first working surface 4 for a first working piece, and then flip the modifier body 14 180 degrees and utilize a second working surface 4 for a second working piece. This increases flexibility and functionality of the modifier body 14.

As depicted, the modifier body 14 has small side holes 16. These enable couplers, such as magnets, to be used for affixing the tool to the plier jaw. The transverse channel 8 enables the tool to be interlocked with the jaw when the work piece is engaged. In this embodiment there are several holes 17 along the side in which couplers 1 can be affixed to help hold ferrous work pieces along the side. The bottom surface is perpendicular to side face 20 making the magnetically affixed or secondary clamped work on face 20 perpendicular to the work surface clamped against the bottom surface. The v-groove 5 allows round parts to be clamped. The groove is offset from the clamping grooves to create a moment forcing the plier jaws farther into the block instead of allowing it to pivot out. Not shown, a v-groove could be added to the side face 20 as well to enable round parts to be clamped against the side. Thus, a single modifier body 14 can have multiple various working surfaces 4.

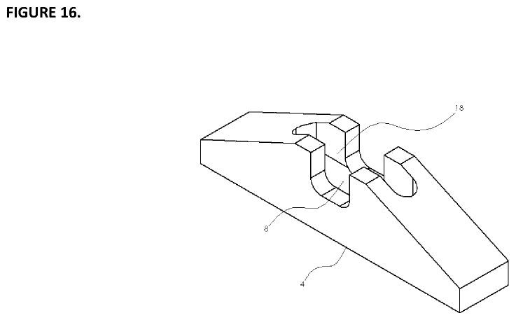

FIG. 16 shows one embodiment of the C-clamp pliers jaw modifiers with an elongated clamping surface. Couplers 1, such as magnets, are affixed to the jaw modifier 14 using and a channel is used to cradle the pier types. The slot 18 provides a place for the coupler to be affixed to the body 14 by adhesive or plastic deformation of the surrounding material. The working surface 4 here is elongated and stiff for spreading the force along a part

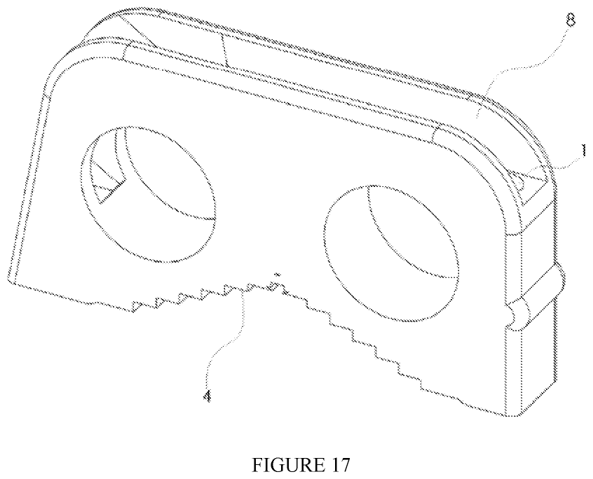

FIG. 17 shows one embodiment of the C-clamp pliers jaw modifiers with a form that can be placed within the “C” portion of the locking pliers. The top channel also has a counter bore large enough such that the jaw modifier can be rotated relative to the channel after clamping. The side magnets realign the jaw modifier with the pliers body after the jaws are disengaged from the workpiece.

While the invention has been particularly shown and described with reference to a preferred embodiment, it will be understood by those skilled in the art that various changes in form and detail may be made therein without departing from the spirit and scope of the invention.

What is claimed is:

1. A plier comprising:
at least onejaw;
a jaw modifier body coupled to said at least one jaw via at least one coupler;
wherein said jaw modifier body comprises a working surface to engage a work piece.

2. The plier of claim 1 wherein said at least one coupler comprises a magnet.

3. The plier of claim 1 wherein said jaw modifier body comprises a hole for receiving a coupler.

4. The plier of claim 1 wherein said coupler comprises a set screw.

5. The plier of claim 1 wherein said coupler is a non-permanent coupler.

6. The plier of claim 1 wherein said jaw modified body is coupled to said at least one jaw via at least two couplers.

7. The plier of claim 1 wherein said working surface is planar.

8. The plier of claim 1 wherein said working surface comprises a protrusion.

9. The plier of claim 1 wherein said jaw modifier body comprises at least one hole to house said at least one connector.

10. The plier of claim 1 wherein said jaw modifier body comprises at least two holes for housing couplers, and wherein said jaw modifier body comprises a transverse channel connecting said at least two holes.

11. The plier of claim 1 wherein said jaw modifier body comprises at least two dissimilar working surfaces.

12. The plier of claim 1 wherein said jaw modifier body comprises a groove to receive a jaw.

13. The plier of claim 1 wherein said working surface comprises a V-grooved face.

14. The plier of claim 1 wherein said jaw modifier body comprises a channel which can receive said jaw.

15. The plier of claim 1 wherein said jaw modifier body comprises a slot through at least one side of said body, wherein said slot receives a jaw of said plier.

16. The plier of claim 1 comprising at least one pair of opposing jaws.

17. A jaw modifier body for coupling with a pair of jaws from a plier, said body comprising:
two jaw modifier bodies;
wherein each jaw modifier bodies are each coupled to at least one coupler;
wherein each of said jaw modifier body comprises a working surface to engage a work piece.
